(19) United States
(12) Patent Application Publication
(10) Pub. No.: US 2011/0029236 A1
(43) Pub. Date: Feb. 3, 2011

(54) GPS-BASED WIRELESS NETWORK CONNECTION SELECTION AND NETWORK TOPOLOGY OVERLAY ON SATELLITE GEOGRAPHIC MAP

(75) Inventor: Yi Zhou, San Diego, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS INC.

(21) Appl. No.: 12/510,557

(22) Filed: Jul. 28, 2009

(51) Int. Cl. G01C 21/00

(52) U.S. Cl. 701/208

(57) ABSTRACT

A method enables users to automatically switch available network connections for the current position as indicated by GPS while maintaining Internet connection. The selection of the network connection depends on a network connection profile which may be built up gradually and the score of each connection. Moreover the local network topology for the GPS location may be overlaid on a geographic map as might be generated by satellite imagery to give the user a better understanding of the topology.

### FIELD OF THE INVENTION

The present application is directed generally to intelligent wireless network connection management and network topology overlays on geographic maps.

### BACKGROUND OF THE INVENTION

Wireless devices such as wireless portable computers may have multiple interfaces to connect to the Internet. Some interfaces require communication paths that might be free but have relatively small bandwidths while other interfaces might use communication paths with robust bandwidths but with attendant costs.

As understood herein, given that a mobile computing device might have multiple interfaces with which to communicate, a user might not know the most suitable interface to use for changing requirements and conditions. Furthermore, present principles understand that existing systems for enabling a user to view network topology give the user a less than complete understanding of the topology. For example, some systems permit showing topologies relative to a user-designated home location but not the available topology in a different location unless the user re-designates the new location as the home location, unfortunately leading to the loss of topology presentation related to the previously set home location.

### SUMMARY OF THE INVENTION

Accordingly, a mobile computing device includes a processor, a geographic position satellite (GPS) receiver communicating with the processor, and a display presented demanded images under control of the processor. At least a first wireless wide area network interface communicates with the processor for establishing wireless connectivity between the processor and the Internet. The processor presents on the display a geographic map of a current geographic location of the device as indicated by the GPS receiver. Also, the processor overlays on the geographic map a network topology map indicating network connectivity information for the current geographic location of the device.

Without limitation, the network connectivity information may include images of network paths and nodes. The network connectivity information may further include alphabetic messages indicating whether coverage is available for an associated geographic area.

A second wireless wide area network interface may be provided for communicating with the processor for establishing wireless connectivity between the processor and the Internet. The processor can automatically select which interface to use to communicate with the Internet based at least in part on signals from the GPS receiver. Thus, for example, the first interface can be a WiFi interface and the second interface can be a wireless telephony interface, and the WiFi interface can be selected by the processor when the GPS receiver outputs signals indicating the device is located in a home location, with the wireless telephony interface being selected when the GPS receiver outputs signals indicating the device is moving. If desired, the processor can prompt a user to enter the home location, or the processor may infer the home location based on comparing a signal from the GPS receiver with the geographic map. The geographic map may be obtained from satellite imagery.

In another aspect, a mobile computing device includes a processor, a geographic position satellite (GPS) receiver communicating with the processor, and a display presented demanded images under control of the processor. The device may also include at least a first wireless wide area network interface communicating with the processor for establishing wireless connectivity between the processor and the Internet and at least a second wireless wide area network interface communicating with the processor for establishing wireless connectivity between the processor and the Internet. The processor automatically selects which interface to use to communicate with the Internet based at least in part on signals from the GPS receiver.

In still another aspect, a method includes receiving, at a mobile communication device, GPS location information. The method includes using the GPS location information to establish which one of plural wireless communication interfaces for the device to use to communicate with the Internet, and also using the GPS location information to cause the device to present a geographic map on a display and to overlay on the map network topology information.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic diagram of an example mobile computing device in accordance with present principles;

FIG. 2 is a flow chart of example set up logic;

FIG. 3 is a flow chart of example operating logic for establishing which Internet interface to use based on geographic location;

FIG. 4 is a screen shot of an example geographic map presentation, prompting the user to select whether to overlay a network topology map thereon; and

FIG. 5 is a screen shot of an example geographic map presentation with a network topology map overlaid thereon.

### DETAILED DESCRIPTION OF THE PREFERRED EMBODIMENT

Referring initially to FIG. 1, a mobile computing device 10 includes a lightweight hollow housing 12 typically supporting a visual display 14 and one or more audio speakers 14a. The device 10 also typically includes one or more input/output (I/O devices 16 such as but not limited to keypads, point-and-click devices, voice recognition modules, etc. for inputting signals a processor 18 in the housing 12. The processor 18 controls the presentation on the display 14 and accesses a tangible computer readable storage medium 20 such as solid state storage, disk-based storage, removable storage, and any combination thereof. The medium 20 may store logic executable by the processor 18 in accordance with present principles as well as data such as but not limited to network topology data, geographic map data, etc.

The example computing device 10 may also include multiple interfaces for wirelessly communicating with a network such as the Internet. Each interface typically is associated with a respective circuit/radio etc. In the example shown the device 10 includes a WiFi interface 22, a WiMax interface 24, a wireless telephony interface 26 such as but not limited to a Global System for Mobile Communication (GSM) or Code Division Multiple Access (CDMA) interface, a Long Term Evolution (LTE) interface 28, and a satellite communication interface 30, it being understood that the interfaces shown in FIG. 1 are exemplary only and non-limiting. Also, the mobile computing device 10 can include a position receiver such as a global positioning satellite (GPS) receiver 32. The processor 18 typically communicates with one of the interfaces 22-30 at a time to wirelessly exchange data with a network. The processor 18 also receives geographic position information including latitude/longitude information of the current location of the device 10 from the position receiver 32.

Without limitation, the mobile computing device 10 may be implemented as a mobile computer, a mobile telephone, a mobile personal digital assistant, etc.

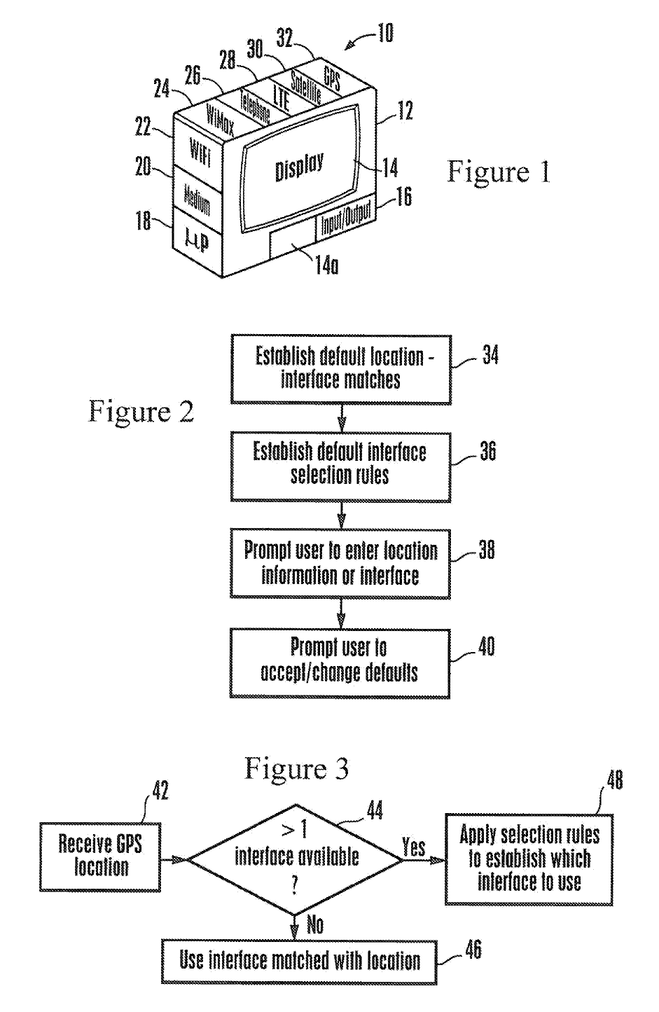

Now referring to FIG. 2, at block 34 default location-interface matches are defined, typically by the manufacturer of the device 10. This may be done either by associating geographic locations input by the user during a registration process with respective wireless interfaces, or by associating generically-named locations (e.g., “home”, “work”, “on the go”) with respective interfaces.

As one example, the location “home” may be associated with the WiFi interface 22, representing a home-based WiFi network, while the location “work” may be associated with the WiMax interface 24, representing a work network. In some cases the WiFi interface 22 may be associated with both home and work for use with different (home and work) WiFi networks. On the other hand, the location “on the go” may be associated with the wireless telephony interface 26.

In addition, anticipating that one of multiple interfaces may be used at any given location, at block 36 default rules are established typically by the manufacturer of the device 10, for selecting which one of two or more available interfaces to use to communicate with the Internet. For example, one rule might be “use fastest connection at work and cheapest connection on the go”, while another rule might be to “use most secure connection on the go”, and so on. Other rules can be predicated on security, wireless speed, wireless signal quality and strength, and cost of using this connection. The various interfaces may then be ranked according to the rules.

At block 38 the processor 18 may present a prompt on the display 14 to enter location information. For example, the processor 18 might present a prompt to “select current location as home, work, or on the go”, and when the user selects, e.g., “home”, the current geographic position of the device 10 as indicated by the output of the GPS receiver 32 is correlated to “home”. Thus, the current geographic position of the device 10 is also correlated with the associated “home” interface. Likewise, when the processor 18 receives a user input of “work” in response to a prompt to select the current location, the GPS position is correlated to the “work” interface. The processor 18 may further infer that the device 10 is “on the go” from changing position information from the GPS receiver 32 that exceeds some threshold rate, e.g., an indication that the device 10 is moving at five miles per hour or faster.

Alternatively, the processor 18 may simply infer that a particular geographic location of the device 10 is “home” or “work”. In one embodiment the processor 18 may receive geographic map information indicating that the current location of the device 10 as indicated by the GPS receiver 32 is in an industrial park. If this location is received at a particular time of day, e.g., between 8 A.M. and 5 P.M., the processor 18 can infer that the device 10 is at “work” and establish the interface used to communicate with the Internet accordingly. Similarly, if the device 10 is located at a map area designated as “residential” after working hours, the device 10 may infer that it is at “home” and establish the interface used to communicate with the Internet accordingly.

Proceeding to block 40, the processor 18 may prompt the user to change default location-interface matches initially established at block 34 as well as to change the default interface selection rules initially established at block 36. When changed, the new interface selections are used to establish wireless Internet connectivity in the associated location.

Block 42 of FIG. 3 indicates that during operation of the device 10, the processor 18 receives geographic position information from the GPS receiver 32. If only a single interface is correlated to the current position at decision diamond 44 (as normally is the case), the processor establishes wireless network connectivity using that interface at block 46. In the event that more than a single interface has been correlated to the current location, at block 48 the rules established at block 36 as modified by user changes at block 40 are used to select the interface for communication.

In addition, the location-interface matches and selection rules may be changed over time gradually based on observing actual usage of the device 10. For example, if a user repeatedly selects the telephony interface 26 to communicate with the Internet when the GPS receiver 32 indicates the user is at “home”, the “home” interface may change from its current setting to “telephony interface 26”.

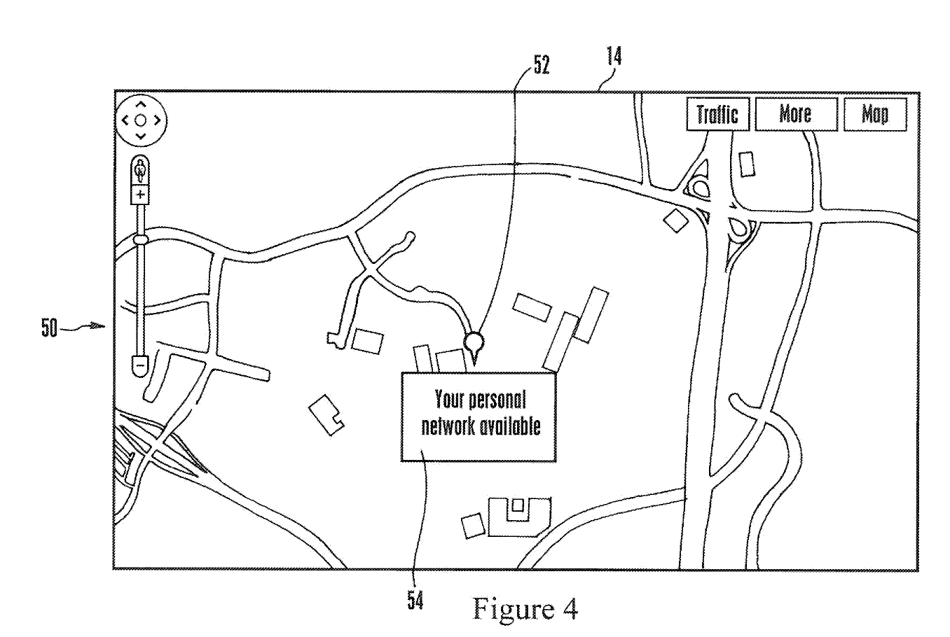

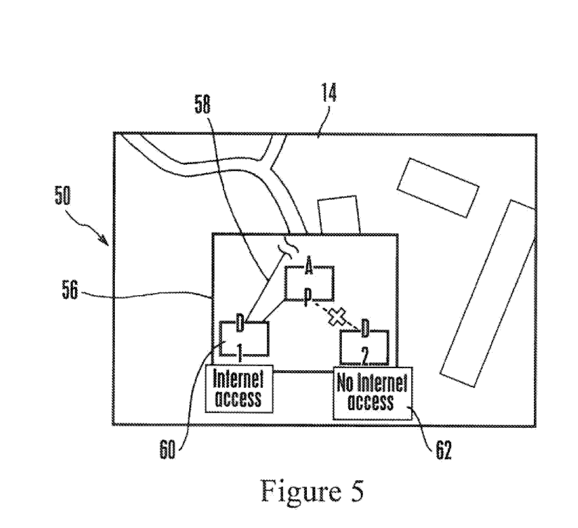

In addition to the above, FIGS. 4 and 5 show that an available network topology may be overlaid on a geographic map 50 and presented on the display 14. The geographic map 50 may be received through one of the interfaces shown in FIG. 1 and may be derived from, e.g., satellite imagery, e.g., the map 50 may be an image of the current geographic location of the device 10 as indicated by the GPS receiver 32. In FIG. 4, as shown at 52 a marker (“A” in FIG. 4) may be presented on the map 50 along with an alphanumeric prompt 54 to the user that a personal network topology is available for display by, e.g., clicking on the marker “A”.

This causes an image 56 of the available wireless network topology to be overlaid on the map 50 as shown in FIG. 5. The topology map indicates network connectivity information for the current geographic location of the device. The network connectivity information may include images 58 of network paths and images 60 of network nodes. Also, the network connectivity information can further include alphabetic messages 62 indicating whether coverage is available for an associated geographic area as shown. Thus, in FIG. 5 no Internet access currently is available in the topology area D2 that exists in the geographic area over which it appears on the map 50, whereas Internet access currently is available in the topology area D1 that exists in the geographic area over which it appears on the map 50. In this way, as the user is being travelling he can relate geographic map information to corresponding wireless network topology information.

In an example embodiment the wireless network topology may be generally existing network topology as detected by the device 10 or the network topology that is made up by the individual user's wireless capable devices at least once. In any case, a convenient way is provided for the user to see the whole personal network topology every setup, with color or other ways to indicate whether a network is available or not at the current location that is obtained by the GPS receiver 32.

While the particular GPS-BASED WIRELESS NETWORK CONNECTION SELECTION AND NETWORK TOPOLOGY OVERLAY ON SATELLITE GEOGRAPHIC MAP is herein shown and described in detail, it is to be understood that the subject matter which is encompassed by the present invention is limited only by the claims.

What is claimed is:

1. A mobile computing device comprising:
a processor;
a geographic position satellite (GPS) receiver communicating with the processor;
a display presented demanded images under control of the processor;
at least a first wireless wide area network interface communicating with the processor for establishing wireless connectivity between the processor and the Internet; wherein
the processor presents on the display a geographic map of a current geographic location of the device as indicated by the GPS receiver, the processor overlaying on the geographic map a network topology map indicating network connectivity information for the current geographic location of the device.

2. The device of claim 1, wherein the network connectivity information includes images of network paths and nodes.

3. The device of claim 2, wherein the network connectivity information further includes alphabetic messages indicating whether coverage is available for an associated geographic area.

4. The device of claim 1, further comprising a second wireless wide area network interface communicating with the processor for establishing wireless connectivity between the processor and the Internet, the processor automatically selecting which interface to use to communicate with the Internet based at least in part on signals from the GPS receiver.

5. The device of claim 4, wherein the first interface is a WiFi interface and the second interface is a wireless telephony interface, and the WiFi interface is selected by the processor when the GPS receiver outputs signals indicating the device is located in a home location, the wireless telephony interface being selected when the GPS receiver outputs signals indicating the device is moving.

6. The device of claim 5, wherein the processor prompts a user to enter the home location.

7. The device of claim 5, wherein the processor infers the home location based on comparing a signal from the GPS receiver with the geographic map.

8. The device of claim 1, wherein the geographic map is obtained from satellite imagery.

9. A mobile computing device comprising:
a processor;
a geographic position satellite (GPS) receiver communicating with the processor;
a display presented demanded images under control of the processor;
at least a first wireless wide area network interface communicating with the processor for establishing wireless connectivity between the processor and the Internet; and
at least a second wireless wide area network interface communicating with the processor for establishing wireless connectivity between the processor and the Internet, the processor automatically selecting which interface to use to communicate with the Internet based at least in part on signals from the GPS receiver.

10. The device of claim 9, wherein the first interface is a WiFi interface and the second interface is a wireless telephony interface, and the WiFi interface is selected by the processor when the GPS receiver outputs signals indicating the device is located in a home location, the wireless telephony interface being selected when the GPS receiver outputs signals indicating the device is moving.

11. The device of claim 10, wherein the processor prompts a user to enter the home location.

12. The device of claim 10, wherein the processor infers the home location based on comparing a signal from the GPS receiver with the geographic map.

13. The device of claim 9, wherein the processor presents on the display a geographic map of a current geographic location of the device as indicated by the GPS receiver, the processor overlaying on the geographic map a network topology map indicating network connectivity information for the current geographic location of the device.

14. The device of claim 13, wherein the network connectivity information includes images of network paths and nodes.

15. The device of claim 14, wherein the network connectivity information further includes alphabetic messages indicating whether coverage is available for an associated geographic area.

16. The device of claim 13, wherein the geographic map is obtained from satellite imagery.

17. A method comprising:
receiving, at a mobile communication device, GPS location information;
using the GPS location information to establish which one of plural wireless communication interfaces for the device to use to communicate with the Internet; and
using the GPS location information to cause the device to present a geographic map on a display and to overlay on the map network topology information.

18. The method of claim 17, wherein the network topology information includes images of network paths and nodes.

19. The method of claim 18, wherein the network topology information further includes alphabetic messages indicating whether coverage is available for an associated geographic area.

20. The method of claim 17, wherein a first interface is a WiFi interface and a second interface is a wireless telephony interface, and the WiFi interface is selected when the GPS location information indicates the device is located in a home location, the wireless telephony interface being selected when the GPS location information indicates the device is moving.
